(19) United States
(12) Patent Application Publication
(10) Pub. No.: US 2014/0339059 A1
(43) Pub. Date: Nov. 20, 2014

(54) Circuit Breaker Having Use Confirmation Insert

(71) Applicants: Michael Jerome Whipple, Rochester, PA (US); Edward Ethber Lias, Aliquippa, PA (US)

(72) Inventors: Michael Jerome Whipple, Rochester, PA (US); Edward Ethber Lias, Aliquippa, PA (US)

(21) Appl. No.: 13/893,745

(22) Filed: May 14, 2013

(51) Int. Cl. H01H 9/02

(52) U.S. Cl. CPC H01H 9/02
USPC 200/293

(57) ABSTRACT

A circuit breaker is described herein that provides a ready visual and haptic indicator of prior use. The circuit breaker comprises a breaker body comprising insulative material. The circuit breaker further comprises a first mounting hole and a second mounting hole, the mounting holes having an inner circumferential dimension presenting a passage and adapted for slidable receipt of a power source. An interrupter is in communication with the first mounting hole and the second mounting hole, with the interrupter operable to terminate electrical flow outside configured parameters. An insert comprises a lip, an arm, a neck, and a tab, the lip being fixed to the breaker body and a first end of an arm. The arm's angularly orientation and length is configured for selective placement of said tab relative to said passage of said mounting hole. The neck is composed of deformable material and joined to second end of said arm. The tab is joined to the neck and coaxially aligned with the passage.

### BRIEF DESCRIPTION OF THE DRAWINGS

For a more complete understanding of the present invention, including its features and advantages, reference is now made to the detailed description of the invention taken in conjunction with the accompanying drawing in which:

FIG. 1 illustrates a top view of a circuit panel having a plurality circuit breakers according to the current invention;

FIG. 2 illustrates a partial exploded view of a circuit panel and an embodiment of the current invention;

FIG. 3 illustrates a side perspective view of an embodiment of a use confirmation insert according to the current invention; and

FIG. 4 illustrates a bottom perspective view of the embodiment of

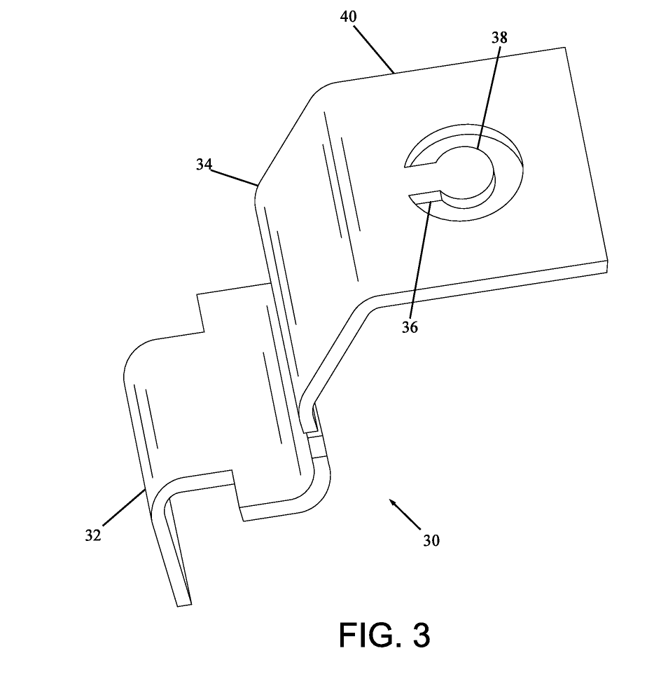

FIG. 3.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

A circuit breaker is an automatically operated electrical switch designed to protect an electrical circuit from damage caused by overload or short circuit. Its basic function is to detect a fault condition and, by interrupting continuity, to immediately discontinue electrical flow by closing the circuit. Generally, a circuit breaker includes a circuit body, an interrupter, and auxiliary elements. The interrupter is operable to terminate electrical flow where the load is outside the configured electrical parameters. Common interrupters include vacuum, gaseous, magnetic, thermal, and other types known in the art.

In desired operation, the interrupter terminates electrical flow when the electrical load is outside the pre-configured parameters (e.g., the circuit breaker is “tripped.”) In practical operation, tripped breakers are often perceived as the reason that electrical equipment ceases to operate. In an attempt to remedy the situation, trained and untrained individuals often seek out the breaker panel and investigate therein. The individual often seeks to replace circuit breakers within the panel. However, when replacing circuit breakers, it is difficult to readily ascertain whether the replacement circuit breaker has been used, unless the circuit breaker is in packaging. This is often not the case in an operating environment.

It would also be advantageous to readily ascertain whether a circuit breaker has been used prior to deployment in a panel without having to resort to costly or time consuming forensic analysis. For at least the above reasons, it would be advantageous to have a circuit breaker with a use confirmation insert for ready ascertainment of prior use.

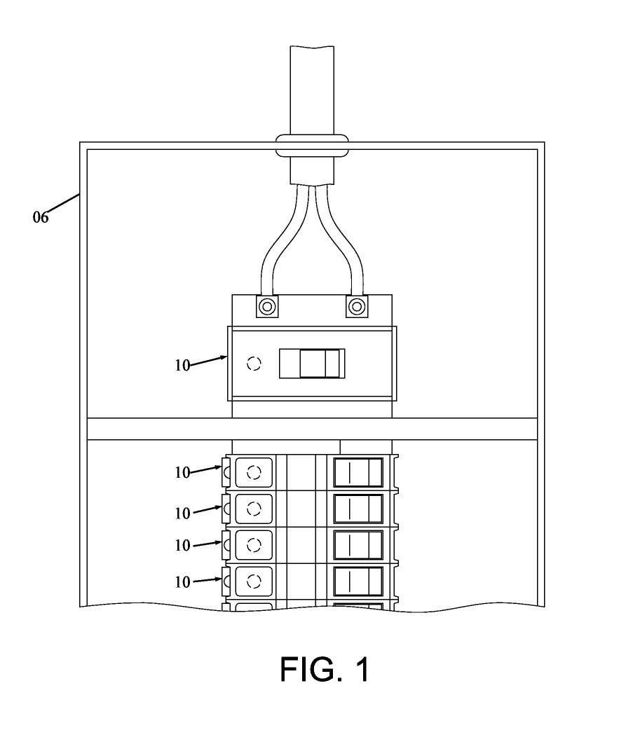

As stated in the brief description of the drawings, FIG. 1 illustrates the a top view of a circuit panel having a plurality circuit breakers according to the current invention.

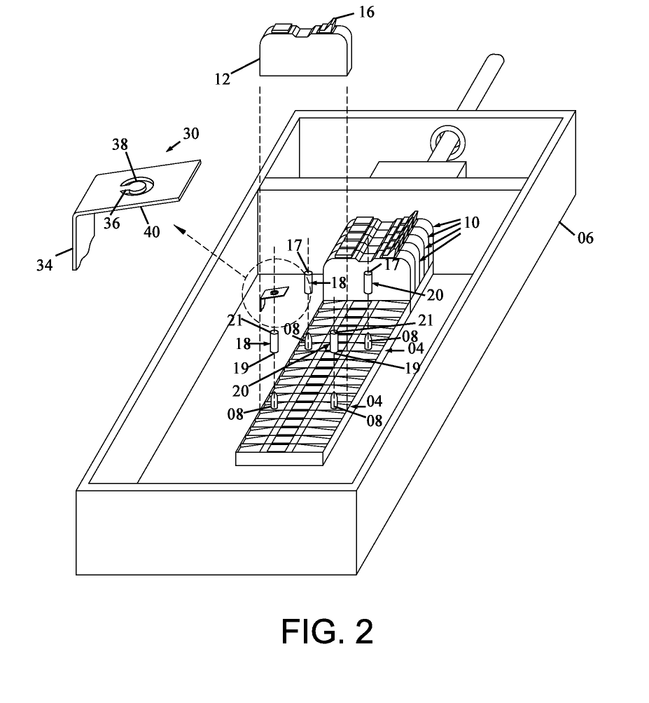

Now referring to FIG. 2, an embodiment of a circuit breaker 10 with a use confirmation insert 30 according to the current invention is disclosed. The circuit breaker 10 with use confirmation insert 30 provides a readily perceptible visual marker of prior use of the circuit breaker. Illustrated are the circuit panel 06 with a plurality of slots 04, each slot 04 adapted for receipt of a circuit breaker 10. The depicted slots 04 and have a pair of power posts 08 operable to provide electricity and adapted for slidable engagement with a circuit breaker 10.

The circuit breaker 10 includes a breaker body 12, an interrupter (not pictured), and a use confirmation insert 30 (Please note that the figure only includes the major components of the circuit breaker for visual clarity). The breaker body 12 includes a housing composed of insulative material. In addition, the breaker body 12 presents an interior region operable to encompass the interrupter and use confirmation insert 30 and shield the interior region from the ambient environment. Optionally, it includes a manual reset switch 16 on its exterior surface.

Disposed in the interior region of the breaker body 12 is a first mounting hole 18 in communication with the interrupter, which in turn, is in communication with a second mounting hole 20. The interrupter is disposed in the interior region of the breaker body 12 and operable to terminate electrical flow through the circuit breaker 10. The interrupter includes vacuum, gaseous, magnetic, thermal, and other types of switches known in the art. The interrupter closes the circuit between the first mounting hole 18 to the second mounting hole 20 when the current is out of the pre-configured range of parameters.

The mounting holes 18 and 20 are dimensioned for slidable engagement with the power posts 08 of a slot 04 within the panel 06, enabling communication between the power posts 08 when the interrupter is in an open circuit state. In an exemplary configuration, the mounting holes 18 and 20 are tubular, presenting a passage 17 and an inner circumferential surface for contact with the power posts 08. The mounting holes 18 and 20 have a lower opening 19 and an upper opening 21. Further, in the exemplary configuration, the mounting holes 18 and 20 are distal to each other, on opposing sides of the circuit breaker 10. Optionally, each mounting hole 18 and 20 includes a line terminal (not pictured) for more resilient contact with the power posts 08. The line terminal may present additional surface area, releasable fasteners, or other features known in the art.

Now referring to FIG. 3, a use confirmation insert 30 is disposed proximate one of the mounting holes 18 or 20 (illustrated in FIG. 2). Although this embodiment employs only a single insert 30 paired with a mounting hole 18 or 20, it is within the spirit of this invention to pair an second insert 30 with the second mounting hole 18 or 20. The insert 30 provides a visual and haptic indicator of prior use of the circuit breaker 10. The insert 30 includes a lip 32, an arm 34, and a tab 38.

The lip 32 is a rigid surface which provides an anchor point for securing to the breaker body 12 (illustrated in FIG. 1). In the exemplary configuration, the lip 32 is a planar surface fixed to an interior sidewall of the breaker body 12.

A first end of the arm 34 is joined to the lip 32 and facilitates selective placement of the tab 38 relative to a mounting hole 18 or 20. The exemplary arm 34 is rigid and extends angularly and upwardly from the lip 32 a configured distance and angle in order to selectively and fixedly position the tab 38 relative to the passage 17 presented by the selected mounted hole 18 or 20.

A neck 36 extends from the second end of the arm 34. In this embodiment, the neck is composed of deformable material. Extending laterally from the neck 36 and distally to the arm 34 is a tab 38 covering at least a portion of the passage 17, lower opening 19, or upper opening 21 of the mounting hole 18 or 20, whereby the tab 38 detaches from the insert 30 upon receipt of the generally transverse force from slidable engagement of the circuit breaker 10 to the power posts 08 of the slot 04. In an exemplary configuration, the tab 38 has a greater width than the neck 36 and the width of the tab 38 is less than the width of the mounting hole 18 or 20. Optionally, the neck 36 has a less thickness than the tab 38, facilitating tab 38 detachment.

In a first configuration, the width of the tab 38 is slightly less than the width of the passage 17. In a second configuration, the width of the tab 38 is greater than the width of the passage 17, lower opening 19, upper opening 21. In a third configuration, the width of the tab 38 is less than half the width of the passage 17, facilitating passage 17 clearance and more resilient post 08 to mounting hole 18 and 20 contact.

In a further optional configuration, the neck 36 and tab 38 are integrated within a plate segment 40. The plate segment 40 includes an annular rim joined to the neck 36 abutting the tab 38 leaving a buffer space around the tab 38. The inner width of the rim corresponds to the width of the mounting hole 18 or 20. In the exemplary configuration, the combined neck 36, tab 38, and plate portion 40 are oriented in a generally planar configuration.

Referring back to FIG. 2, as mentioned, the tab 38 is selectively, fixedly placed to cover at least a portion of the passage 17, lower opening 19, or upper opening 21 of the mounting hole 18 or 20. In a first configuration, the tab 38 is fixedly placed above the upper opening 21 of the mounting hole 18 or 20. In another configuration, the tab 38 is fixedly placed below the lower opening 19 of the mounting hole 18 or 20. In yet another configuration, the tab 38 is fixedly placed inline with the mounting hole 18 or 20.

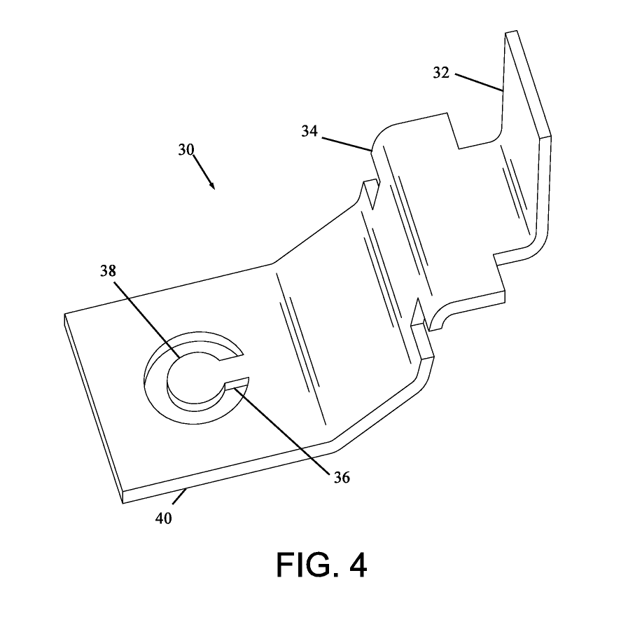

Now referring to FIG. 4 but with reference to FIGS. 1, 2 and 3, the circuit breaker 10 having a use confirmation insert 30 in a panel 06 is described. The circuit breaker 10 is brought proximate a panel 06 slot 04. The circuit breaker 10 is aligned such that its mounting holes 18 and 20 are aligned with power posts 08 of the slot 04. The circuit breaker 10 is slidably engaged to the power posts 08, whereby the power posts 08 contact and dislodge the tab 38 from the use confirmation insert 30, as shown in the plurality of circuit breakers 10 of FIG. 1. Upon disengagement from the slot 04, the tab 38 is no longer visible upon inspection of the circuit breaker 10, indicating prior use. Further, the resistive force provided by the tab 38 no longer exists, also indicating prior use of the circuit breaker 10.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

We claim:

1. A circuit breaker comprising:
a breaker body comprising insulative material;
a first mounting hole and a second mounting hole, said mounting holes having an inner circumferential dimension presenting a passage and adapted for slidable receipt of a power source;
an interrupter in communication with said first mounting hole and said second mounting hole, said interrupter operable to terminate electrical flow outside configured parameters;
an insert comprising a lip, an arm, a neck, and a tab, said lip fixed to said breaker body and a first end of an arm, said arm's angular orientation and length configured for selective placement of said tab relative to said passage of said mounting hole;
said neck composed of deformable material and joined to second end of said arm; and
said tab joined to said neck and substantially coaxially aligned with said passage.

2. The device of claim 1 wherein said tab is disposed proximate said upper end of said mounting hole.

3. The device of claim 1 wherein said tab is disposed proximate said lower end of said mounting hole.

4. The device of claim 1 wherein said tab is disposed inline with said mounting hole.

5. The device of claim 1 wherein the width of said tab is slightly less than the width of said passage.

6. The device of claim 1 wherein the width of said tab is less than half the width of said passage.

7. The device of claim 1 wherein the width of said tab is greater than the width of said passage.

8. The device of claim 1 wherein said neck is less thick than said tab.

9. The device of claim 1 further comprising a plate portion encompassing said tab, said plate portion comprising a buffer zone adjacent to said tab, a rim adjacent to said buffer zone, said buffer zone and said rim concentrically disposed to said tab.

10. The device of claim 1 further comprising a second insert cooperatively disposed with said second mounting hole.

11. A device for use within a circuit breaker having a mounting hole presenting a passage and dimensioned for slidable engagement to a power source, said device comprising:
a lip, an arm, a neck, and a tab;
said lip adapted for joinder to a breaker body and joined to a first end of an arm;
said arm's angularly orientation and length configured for selective placement of said tab relative to said passage of said mounting hole;
said neck composed of deformable material and joined to the second end of said arm; and
said tab joined to said neck and coaxially aligned with said passage, whereby said tab is operable to disengage upon said circuit breaker's slidable engagement to said power source.

12. The device of claim 11 wherein said neck is less thick than said tab.

13. The device of claim 11 wherein the width of said tab is slightly less than a selected passage for cooperative placement.

14. The device of claim 11 wherein the width of said tab is half of that of a selected passage for cooperative placement.

15. The device of claim 11 wherein the width of said tab is greater than that of a selected passage for cooperative placement.

16. The device of claim 11 further comprising a plate portion encompassing said tab, said plate portion comprising a buffer zone adjacent to said tab, a rim adjacent to said buffer zone, said buffer zone and said rim concentrically disposed to said tab.
